(19) United States
(12) Patent Application Publication
(10) Pub. No.: US 2025/0060711 A1
(43) Pub. Date: Feb. 20, 2025

(54) SYSTEMS AND METHODS FOR SIMULATION-BASED REAL TIME PRODUCTION CONTROL

(71) Applicants: Feng Ju, Chandler, AZ (US); Feifan Wang, Tempe, AZ (US)

(72) Inventors: Feng Ju, Chandler, AZ (US); Feifan Wang, Tempe, AZ (US)

(73) Assignee: Arizona Board of Regents on Behalf of Arizona State University, Tempe, AZ (US)

(21) Appl. No.: 18/809,126

(22) Filed: Aug. 19, 2024

Related U.S. Application Data
(60) Provisional application No. 63/533,546, filed on Aug. 18, 2023.

(51) Int. Cl. G05B 13/04

(52) U.S. Cl. CPC G05B 13/047; G05B 13/042

(57) ABSTRACT

A computer-implemented model is trained or otherwise configured for real-time production control. The model incorporates a plurality of classes of residence time control and optimizes produce performance by managing an associated machine's behavior according to real-time system states. The model can formulate a Markov decision process and feature-extraction method and feature-based approximation architecture to reduce state space of the model. Simulation is employed in training to estimate parameters of feature-based approximate architecture to obtain a lookahead function of the Markov decision process.

### CROSS REFERENCE TO RELATED APPLICATIONS

This is a non-provisional application that claims benefit to U.S. Provisional Application Ser. No. 63/533,546, filed on Aug. 18, 2023, which is herein incorporated by reference in its entirety.

### GOVERNMENT SUPPORT

This invention was made with government support under 1922739 awarded by the National Science Foundation. The government has certain rights in the invention.

### FIELD

The present disclosure generally relates to computer-implemented production and control models; and in particular to systems and methods for an artificial intelligence (AI) driven simulation-based real-time control method configured to perform production control in face of a plurality of classes of residence time constraints.

### BACKGROUND

A production control problem that is commonly seen in real-world factories is to maximize production rate and minimize scrap rate where the time that a part spends in one or several consecutive buffers is restricted. To optimize the production performance such as production rate and scrap rate, one needs to properly manage all associated machines' behavior to prevent from producing too many intermediate parts with high risk of scrap. However, production control in this context must address various challenges, e.g., the large state space of the problem posed, and that control methods should be flexible to handle different structures.

It is with these observations in mind, among others, that various aspects of the present disclosure were conceived and developed.

### BRIEF DESCRIPTION OF THE DRAWINGS

FIG. 1 is an illustration of a serial line associated with an inventive concept described herein.

FIG. 2 is an illustration of four different classes of residence time constraints associated with the inventive concept as described herein.

FIG. 3A is a chart illustrating aspects of a class C1 associated with an improved reward by simulation-based control described herein.

FIG. 3B is a chart illustrating aspects of a class C1 associated with an improved reward by simulation-based control described herein.

FIG. 3C is a chart illustrating aspects of a class C1 associated with an improved reward by simulation-based control described herein.

FIG. 3D is a chart illustrating aspects of a class C1 associated with an improved reward by simulation-based control described herein.

FIG. 4 is an illustration of a system for supporting an artificial intelligence (AI) driven simulation-based real-time control method configured to perform production control in face of a plurality of classes of residence time constraints.

FIG. 5 is a simplified block diagram of an example process flow associated with the inventive concept of an artificial intelligence (AI) driven simulation-based real-time control method configured to perform production control in face of a plurality of classes of residence time constraints described herein.

FIG. 6 is a simplified illustration of an example computing device that can be implemented by the system to perform various functions, operations, or other features described herein.

Corresponding reference characters indicate corresponding elements among the view of the drawings. The headings used in the figures do not limit the scope of the claims.

### DETAILED DESCRIPTION

The present disclosure relates to a simulation-based real-time control system/method to perform production control related to residence time. It can improve performance in the face of four classes of residence time constraints commonly seen in semiconductor manufacturing. This method optimizes production performance such as production rate and scrap rate by managing all machine's behavior according to real-time system states. This can prevent the system from producing too many intermediate parts with risk of scrap.

### 1. INTRODUCTION

Advances in information and communication technologies enable production systems to respond to production uncertainties quickly and provide potentials to improve the manufacturing efficiency and quality through real-time production control. One production control problem that is commonly seen in real-world factories is to maximize production rate and minimize scrap rate of a production system with residence time constraints. One example of production systems with residence time constraints is a semiconductor packaging and testing line, where intermediate semiconductor packages are not allowed to stay in buffer for long primarily for two reasons. First, moisture absorption into polymers of semiconductor packages decreases interfacial adhesion and causes cracks later in reflow process. In addition, long time stay of an intermediate semiconductor package in buffer can lead to oxidation on the surface of its die. Similar problems are also found in semiconductor fabrication, food industry, and battery production.

The issue of residence time has received mounting attention in production literature in recent years. One paper studied the distribution of residence time of parts in the buffer for a two-machine transfer line, and the risk of scrap is evaluated based on the derived distribution. Such residence time, especially counting from part entry to the system to the departure from the system, is often referred to as lead time or sojourn time in the literature as well. For instance, other papers consider lead time in a three-machine transfer line, a production system with closed loop and a two-machine multi-product system, respectively. Another paper extends the study on residence time distribution to transfer lines with multiple machines and obtains residence time distribution for each buffer. All these studies on residence time mentioned above assume that defective parts are not scrapped until they finish the last process at the end of the production line. In many applications, parts that violate residence time constraints are scrapped immediately, and it imposes difficulties in capturing system dynamics. Yet further papers take residence time into modeling of two-machine serial lines, and the system dynamics can be captured as defective parts are scrapped immediately. Longer serial lines with defective parts immediately scrapped are studied as an extension of two-machine serial lines. Another paper introduces the quality buy rate to model system dynamics and derives steady-state system performance of Bernoulli lines. Still others in the field consider a Bernoulli line where each machine inspects the quality of parts, and parts with residence time larger than a limit have a certain probability of being scrapped. In other word, a method to evaluate both transient behavior and steady-state behavior of geometric serial lines was proposed.

Despite of all the above-mentioned efforts, limited work has been reported on real-time production control with residence time constraints due to its complexity. Others provide methods to perform real-time control, but those methods are only applied to small-sized systems with two machines and one buffer. Thus, one challenge is the large state space of the problem, as one is dealing with a longer serial line. Besides, early studies define residence time constraints for a single buffer or for the whole system, but residence time constraints could have a more complex structure according to what has been observed in semiconductor manufacturing. It leads to another challenge that a proper control method is supposed to be flexible to handle different structures of residence time constraints.

In the following disclosure of the present inventive concept, a simulation-based real-time control method is proposed and intended to overcome the two challenges. Specifically, four basic classes of residence time constraints, covering a wide range of practical applications, are introduced. A Markov Decision Process (MDP) model is formulated, and a feature extraction method and a feature-based approximate architecture are proposed to reduce the state space of the MDP model. Simulation is applied in the training to estimate parameters of the feature-based approximate architecture, so the lookahead function in the MDP model can be approximately obtained. Simulation experiments suggest that such a method leads to significant system performance improvement with low computation overhead, which makes real-time production control feasible for longer serial lines with different classes of residence time constraints.

### II. PROBLEM FORMULATION

### A. Serial Production Line

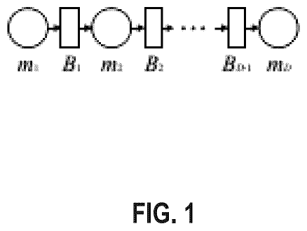

The serial line under study is shown in FIG. 1. Parts visit each machine and buffer from the left side to the right side, until they finish all the processes or get scrapped. The following assumptions define the machines, the buffers, and their interactions.
i. The serial line consists of D machines, denoted by m₁, m₂, . . . , m_{D} and (D−1) buffers, denoted by B₁, B₂, . . . , B_{D-1}
ii. All machines are synchronized with a constant processing time (cycle time), which is the time to process a single part.
iii. Machines are subject to failures. The state of machine mᵢ, for i=1, . . . , D, is determined at the beginning of a cycle, and it follows the Bernoulli distribution with parameter pᵢ. Specifically, machine mᵢ is capable of producing a part in a cycle with probability pᵢ and fails to do so with probability (1-pᵢ). Residence time constraints are usually the concern in practice, when the upstream machines in a serial line have higher efficiency than the downstream machines. Thus, pᵢ≥pⱼ is assumed, for all i and j such that 1≤i≤j D.
iv. Buffer Bᵢ has a finite capacity Nᵢ(1≤Nᵢ≤∞), for i=1,2, . . . , D−1, and its buffer occupancy, denoted by nᵢ, is determined at the end of a cycle. First-in-first-out (FIFO) policy is assumed regarding the buffer outflow process.
v. Each part is under residence time constraints, represented by Tᵢⱼ, where 1≤i<j≤D. Let [symbol] be the set of all residence time constraints. The time that [symbol] a part spends between the process on machine mi and the process on machine mⱼ must be smaller than Tᵢⱼ, if Tᵢⱼ∈ [symbol] . Otherwise, the part will be scrapped immediately.
vi. Machine mᵢ, for i=1,2, . . . , D−1, is blocked during a cycle, if (a) machine mᵢ is up, (b) buffer Bᵢ is full, (c) machine mᵢ₊₁ does not produce a part in this cycle due to machine failure or blockage, and (d) there will be no part scrapped from buffer Bᵢ. Machine m_{D} is never blocked. In addition, block-before-service policy is assumed.
vii. Machine mᵢ, for i=2, . . . , D, is starved during a cycle, if machine mᵢ is up, and buffer Bᵢ₋₁ is empty. Machine m₁ is never starved.
viii. At the end of each cycle, a machine can be turned down manually to prevent it from producing parts in the next cycle. One can also have a machine unchanged, and thus the machine will work as a Bernoulli machine in the next cycle. It is always beneficial to not change the work mode of the last machine. Let A⊏{1,2, . . . , D−1} be the index set of machines that can be turned down. Denote by aᵢ(t)∈{1,0}, for i∈A and t=0,1, . . . , the action on machine mᵢ at the end of cycle t+1. The action aᵢ(t)=1 makes machine mᵢ not work in cycle (t+1). The action aᵢ(t) represents that machine mᵢ is unchanged and will work as a Bernoulli machine in cycle (t+1). The control space is denoted by [symbol] ={0,1}^{|A|}. Let a(t)∈ [symbol] be an action on the serial line in cycle t.

To evaluate and control the serial line, we introduce the performance measures of interest as follows.
Production rate, PR(t) for t=1,2, . . . : the expected number of parts produced by machine m_{D} in cycle t;
Scrap rate, SR(t) for t=1,2, . . . : the expected number of parts scrapped from the serial line in cycle t.

In practice, it is desired to have a large production rate PR(t) and a small scrap rate SR(t). The objective of the study is to maximize (PR(t)−ωSR(t)), where ω is a positive constant. This paper studies real-time production control through actions provided by assumption (viii) to improve system performance of a serial line given by assumptions (i) to (vii).

### B. Residence Time Constraints

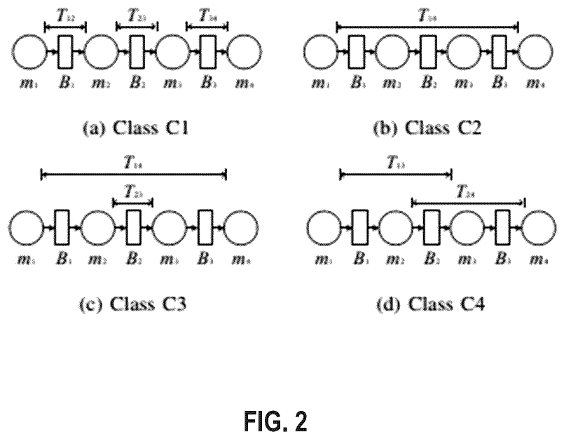

Leveraging teachings from Klemmt and Monch, (A. Klemmt and L. Monch, “Scheduling jobs with time constraints between consecutive process steps in semiconductor manufacturing.” in Proceedings of the 2012 Winter Simulation Conference (WSC) pp. 1-10, IEEE, 2012), we categorize residence time constraints into four basic classes. FIG. 2 shows an example for each class of residence time constraints.
Class C1. It is a class of residence time constraints between two immediately consecutive processes. Thus, each residence time constraint restricts a buffer, and we have j=i+1 for all residence time constraint Tᵢⱼ.
Class C2. A residence time constraint in this class is between two consecutive but not adjacent processes and puts a limit on a segment of a serial line, consisting of more than one buffer. We have j>i+1 for residence time constraint Tᵢⱼ.
Class C3. In this class, two nested residence time constraints exist. A buffer can belong to two segments restricted by two different residence time constraints. We have i≤k and j≥l for two different residence time constraints Tᵢⱼ and Tₖₗ. This class can be generalized to a case with more than two nested residence time constraints.
Class C4. An overlapping exists in this class, but two residence time constraints are not nested. FIG. 2d illustrates Class C4 with two different residence time constraints Tᵢⱼ and Tₖₗ, where i≤k, j<l and k<j This class can be generalized to a case with more than two overlapping residence time constraints.

It can be observed that machine mᵢ, for i=1,2, . . . , D−1, can be properly controlled (on/off) to improve system performance only when there exists residence time constraint Tᵢⱼ∈ [symbol] . Thus, we have A={i|Tᵢⱼ∈ [symbol] .

### III. MODELING

### A. Formulation of MDP Model

The state of a part in the serial line can be defined by

$$s = ( τ , b ) , \qquad ( 1 )$$

where τ=[T₁ T₂ . . . ]^{T} records the residence time of the part, and b specifies that the part is in buffer B_{b}.

For a part in a serial line of Class C1 or Class C2, only a single residence time constraint in [symbol] has an effect on the part at any time, so only a single residence time is required to be recorded. Thus, τ becomes a one-dimensional vector. For instance, when a new part enters the system, the state of the part is (τ1=0, b=1). The residence time τ₁ of the part increases by one each cycle, if the part is restricted by the same residence time constraint. When a part moves out of one residence time constraint and enters a buffer restricted by another residence time constraint, then τ1 is set to be zero. The part is allowed to stay in the system, if the following is satisfied.

$${τ}_{1} \leq {T}_{ij} - j + b , for {T}_{ij} ∈ such that i \leq b < j \qquad ( 2 )$$

Otherwise, the part is scrapped immediately.

For the cases of Class C3 and C4, there are overlapping residence time constraints. Consider a serial line with two overlapping residence time constraints, denoted by Tᵢⱼ and Tₖₗ. τ for a part is expressed as τ=[τ₁, τ₂]^{T}, where τ₁ is residence time under constraint Tiⱼ and τ2 is residence time under constraint τₖₗ. The initial state of a part is (τ=[0 0]^{T}, b=1). If the part is in the buffer under constraints Tᵢⱼ and/or Tₖₗ, τ₁ and/or τ₂ will increase by one each cycle. The part is allowed to stay in the system, if the following constraints are satisfied.

$${τ}_{1} \leq {T}_{ij} - j + b , if i \leq b < j \qquad ( 3 )$$

$${τ}_{2} \leq {T}_{kl} - l + b , if k \leq b < l \qquad ( 4 )$$

Let H(t) be the set of the states of all parts in the serial line in cycle t. We use H(t) to define the system state of the serial line. Denote [symbol] by the state space. In this model, the initial state H(0) is assumed to be known, and then the MDP model is introduced as follows.
Reward function: The reward function, for t=1,2, . . . is denoted by r(H(t−1), a(t−1)). Specifically,

$$r ( H ( t - 1 ) , a ( t - 1 ) ) = ( t ) - ω ( t ) , \qquad ( 5 )$$

where [symbol] (t) and [symbol] (t) are the number of parts produced by machine m_{D} and the number of parts scrapped from the serial line in cycle t, respectively. As the action a(t−1) is being taken, both the number of produced parts and the number of scrapped parts in cycle t are unknown. Thus, [symbol] t(t) and [symbol] (t) are random variables.
The expected total discounted reward of policy τ for any initial state H(0):

$${v}^{π} ( H ( 0 ) ) = {E}^{π} \{ {\sum }_{i = 0}^{∞} {λ}^{i} r ( H ( i ) , a ( i ) ) \} , \qquad ( 6 )$$

where λ∈[0, 1) is the discount, and control policy is a map π: [symbol] [symbol] [symbol]
The optimal expected total discounted reward:

$${v}^{*} ( H ( 0 ) ) = {max}_{π} {E}^{π} \{ {\sum }_{i = 0}^{∞} {λ}^{i} r ( H ( i ) , a ( i ) ) \} . \qquad ( 7 )$$

The optimal control policy:

$${π}^{*} ∈ arg {max}_{π} {E}^{π} \{ {\sum }_{i = 0}^{∞} {λ}^{i} r ( H ( i ) , a ( i ) ) \} \qquad ( 8 )$$

If the optimal expected total discounted reward ν^{π}(H(t)) is known for any state H(t)∈ [symbol] the optimal action at the end of cycle (t−1) can be obtained as follows.

$${a}^{*} ( t - 1 ) ∈ arg {max}_{a ( t - 1 ) {∈}^{𝒜}} E \{ r ( H ( t - 1 ) , a ( t - 1 ) ) + λ {v}^{*} ( H ( t ) ) \} . \qquad ( 9 )$$

The value iteration and the policy iteration are two widely used iterative methods to solve MDP model and estimate ν*(H(t)) and a*(t). However, the model in this paper cannot be solved by either method directly due to its large state space. Alternatively, a simulation-based method will be introduced to address the problem.

### B. Feature-Based Approximate Architecture

The consideration of residence time constraints brings a large state space even for a two-machine serial line. In the problem described herein with multiple machines, the state space is much larger, and it is impossible to obtain ν*(H(t)), making it infeasible to obtain the optimal action through Equation (9). To address the problem, we apply the feature-based architecture to reduce the dimensionality of the problem and introduce an approximate lookahead function \hat{ν}(ϕ(H(t)), β) to replace ν*(H(t)). Function ϕ(H(t)) represents the feature extraction that maps system state H(t) into a feature vector. The lookahead function is then approximated by linearly weighting the features. Specifically,

$$\hat{v} ( ϕ ( H ( t ) ) , β ) = {β}^{T} ϕ ( H ( t ) ) , \qquad ( 10 )$$

where β is a vector of parameters estimated through simulation, and the details are presented in Section III-C. Thus, Equation (9) can be rewritten as follows.

$${a}^{*} ( t - 1 ) ∈ arg {max}_{a ( t - 1 ) {∈}^{𝒜}} E \{ r ( H ( t - 1 ) , a ( t - 1 ) ) + λ \hat{v} ( ϕ ( H ( t ) ) β ) \} \qquad ( 11 )$$

Due to the large state space, the optimal control π* that maps system state H(t) to the optimal action a*(t) cannot be written explicitly as a lookup table. Therefore, β is stored to represent the optimal control policy π* to map system state to the optimal action through Equation (11).

The number of parts in the segment of the serial line restricted by a residence time constraint and the residence time of the head part in the segment are two important features of the segment. A simulation model of Class C1 was developed to study the effect of features on the system performance. The simulation experiment suggests that the buffer occupancy should not be either too small or too large. Small buffer occupancy reduces the production rate because of a high probability of starvation for the downstream machines. Large buffer occupancy increases risk of scrap. In addition, the simulation experiment also shows that a small residence time is always preferred. Thus, three features are adopted to describe the segment of the serial line limited by a residence time constraint. They are the number of parts in the segment, the square of the number of parts in the segment and the residence time of the head part in the segment. With a constant term included, the dimension of both ϕ(H(t)) and β is (3| [symbol] |+1), and ϕ(H(t)) is expressed as follows.

[symbol]

$$ϕ ( H ( t ) ) = {[ {ϕ}_{1} {ϕ}_{2} {⋯ϕ}_{3 \vert 𝒥 \vert + 1} ]}^{T} . \qquad ( 12 )$$

The first feature ϕ₁ is set to be one as a constant term. Let the ith residence time constraint in the [symbol] be for i=1,2, . . . , | [symbol] |. The features of the segment of the serial line covered by Tⱼₖ are

$${ϕ}_{3 i - 1} = {\sum }_{l = j}^{k - 1} {n}_{l} , \qquad ( 13 )$$

$${ϕ}_{3 i} = {( {\sum }_{l = j}^{k - 1} {n}_{l} )}^{2} ,$$

$${ϕ}_{3 i + 1} = τ ,$$

where τ is the value of the dimension in τ, corresponding to residence time constraint Tⱼₖ, of the head part in the segment.

### C. Training and Implementation

The purpose of the training is to estimate parameter β through simulation, so \hat{ν}(ϕ(H(t)), β) can become the estimate of ν*(H(t)) and replace ν*(H(t)) in Equation (9). The procedure of the training is provided as follows.
Step 1: Initialize the setting for the training. Set the number of iterations of the policy iteration method to be I. A total number of simulation runs is set to be K in each iteration of the policy iteration method. Simulation starts from cycle 0 and ends in cycle J.
Step 2: Let the index i be one. Set the initial control policy, denoted by π⁰, to be a policy that never turns any machine down.
Step 3: Start the ith iteration of the policy iteration method. Randomly generate K initial system states, denoted by H^{k}(0) for k=1,2, . . . , K. Control policy πⁱ⁻¹ is applied to each simulation run. The parameter for the ith iteration, denoted by βⁱ, is estimated through least squares estimation as follows.

$${β}^{i} ∈ arg {max}_{β} {\sum }_{k = 1}^{K} {( \hat{v} ( ϕ ( {H}^{k} ( 0 ) ) , β ) - {\sum }_{j = 1}^{J} {λ}^{j - 1} r ( {H}^{k} ( j - 1 ) , a ( j - 1 ) ) )}^{2} , \qquad ( 14 )$$

where Σⱼ₌₁^{j}λ^{j-1} r(H^{k}(j−1), a(j−1)) represents the total discounted reward of the realization of the kth simulation run.
Step 4: The control policy for the ith iteration, πⁱ, is obtained and represented using parameter βⁱ. The maps from system state H(t−1) to the optimal action under control policy πⁱ is obtained as follows.

$${a}^{*} ( t - 1 ) ∈ arg {max}_{a ( t - 1 ) {∈}^{𝒜}} E \{ r ( H ( t - 1 ) , a ( t - 1 ) ) + λ \hat{v} ( ϕ ( H ( t ) ) {β}^{i} ) \} \qquad ( 15 )$$

Step 5: Increase index i by one. If the index i is greater than I, go to step 6. Otherwise, go to step 3.
Step 6: Validate the control policy. There is a small chance that the training does not go in the improving direction, especially when the size of the problem is large and the number of residence time constraints is large. The obtained control policy will only be applied if it delivers system performance improvement according to the simulation.

The training can be performed offline. The resulting control policy π* is represented by the estimated β. To implement the control policy at the end of cycle (t−1) with an observed system state H(t−1), the optimal action is obtained online by Equation (11). The computing time to run Equation (11) is small, and small reaction time of the system can be guaranteed to support real-time capability. Serial lines of different classes need to be trained separately but following the same procedures.

### IV. Performance Evaluation

The simulation-based real-time control method is developed with MATLAB, and the experiment runs on a computer with Intel(R) Core(TM) i7-8700 CPU, 16 GB RAM, and 64-bit Windows 10 Enterprise operating system.

To test the proposed method in a more general sense, parameter settings are randomly selected from a given range shown as follows.

$$\begin{matrix}D ∈ \{ 4 , 5 , 6 \} , \\ {p}_{i} ∈ [ 0.5 , 0.99 ] for i = 1 , ⋯ , D , \\ {N}_{i} ∈ \{ 4 , 5 , 6 , 7 \} for i = 1 , ⋯ , D - 1 , \\ ω ∈ [ 0.7 , 1.7 ] .\end{matrix} \qquad ( 16 )$$

pᵢ, for i=1, . . . , D, is sorted in a descent order. Discount λ is set to be 0.95. Simulation runs 300 cycles each time from an initial state with all buffer empty. Residence time constraints are randomly generated. For Class C1, we have

$${T}_{i i + 1} ∈ \{ {N}_{i} + 1 , {N}_{i} + 2 , {N}_{i} + 3 \} for i = 1 , ⋯ , D - 1 \qquad ( 17 )$$

For Class C2, we have

$${T}_{1 D} ∈ \{ {\sum }_{k = 1}^{D - 1} {N}_{k} + 1 , {\sum }_{k = 1}^{D - 1} {N}_{k} + 2 , {\sum }_{k = 1}^{D - 1} {N}_{k} + 3 \} . \qquad ( 18 )$$

We define two residence time constraints for serial lines of Class C3 as follows.

$${T}_{1 D} ∈ \{ {\sum }_{k = 1}^{D - 1} {N}_{k} + 1 , {\sum }_{k = 1}^{D - 1} {N}_{k} + 2 , {\sum }_{k = 1}^{D - 1} {N}_{k} + 3 \} , \qquad ( 19 )$$

$$and$$

$${T}_{ij} ∈ \{ {\sum }_{k = i}^{j - 1} {N}_{k} + 1 , {\sum }_{k = i}^{j - 1} {N}_{k} + 2 , {\sum }_{k = i}^{j - 1} {N}_{k} + 3 \} , \qquad ( 20 )$$

where i∈[1, D−1]∩ [symbol] and j∈[i+1, i+min(D−i,D−2)]∩ [symbol] . In the experiment for serial lines of Class C4, the residence time constraints are [symbol] selected in the range shown as follows.

$${T}_{1 i} ∈ \{ {\sum }_{k = 1}^{i - 1} {N}_{k} + 1 , {\sum }_{k = 1}^{i - 1} {N}_{k} + 2 , {\sum }_{k = 1}^{i - 1} {N}_{k} + 3 \} \qquad ( 21 )$$

$$and$$

$${T}_{jD} ∈ \{ {\sum }_{k = j}^{D - 1} {N}_{k} + 1 , {\sum }_{k = j}^{D - 1} {N}_{k} + 2 , {\sum }_{k = j}^{D - 1} {N}_{k} + 3 \} \qquad ( 22 )$$

where i∈[3, D−1]∩n [symbol] and j∈[2, i−1]∩

[symbol]

TABLE I
Performance of simulation-based control

| | Average | Average | Average |
|---|---|---|---|
| | reward per | reward per | relative |
| | cycle without | cycle with | improvement |
| Class | control | control | with control |
| C1 | 0.2331 | 0.3849 | 65.12% |
| C2 | 0.2680 | 0.5502 | 105.30% |
| C3 | 0.2739 | 0.5244 | 91.46% |
| C4 | 0.2972 | 0.5359 | 80.32% |

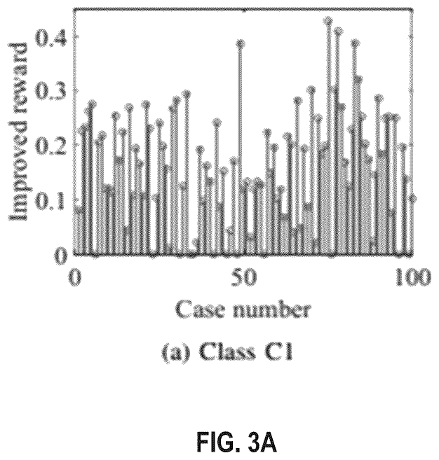

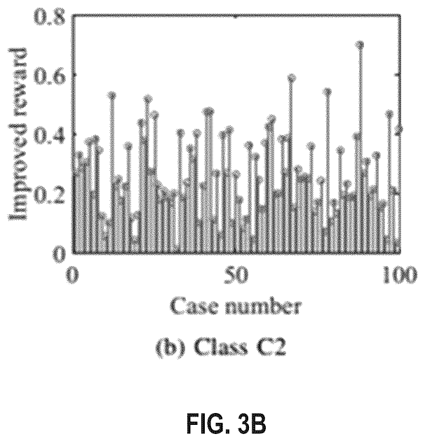

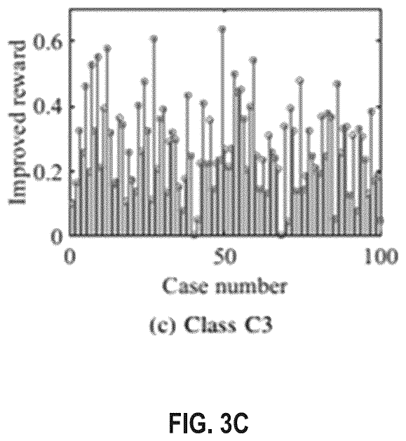

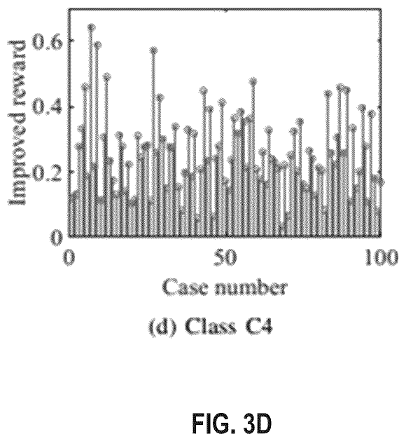

We randomly generate 200 parameter settings for each class of serial lines. Simulation for each parameter setting runs 300 cycles with 100 replications. The average reward (PR(t)−ωSR(t)) of each cycle from cycle 101 to 300 in each repeat is calculated and compared. FIG. 3 shows that the improved rewards of most cases can be beyond 0.1 for serial lines of Class C1 and greater than 0.15 for the three other classes. TABLE I presents statistics for further comparison. The second column of the table presents the average reward where all machines keep working with no control to turn a machine down. The third column gives the average reward of the proposed method. The average relative improvement with control is calculated and listed on the table, showing a large improvement of the simulation-based real-time control.

### V. Conclusions

Residence time of parts is commonly restricted in many production systems. Due to the complexity of these systems, resulting from the large state space of the problem and diverse structures of residence time constraints, it is difficult to perform real-time production control to improve production performance such as production rate and scrap rate. This paper is intended to contribute to this end. Four basic classes of residence time constraints, covering a wide range of practical applications, are introduced. A feature extraction method and a feature-based approximate architecture are proposed to reduce the complexity of the problem and obtain real-time production control policy. Simulation experiments suggest significant system performance improvement of such a method. The future research can be directed to investigating structural properties of each class of residence time constraints, and thus the simulation-based control method can improve further through feature selection and feature-based approximate architecture. In addition, it is worth exploring the performance of the proposed method in mathematical models of production systems with different assumptions, such as queueing network, serial line with a more general machine reliability model, etc., to further determine the impact of different assumptions on feature selection.

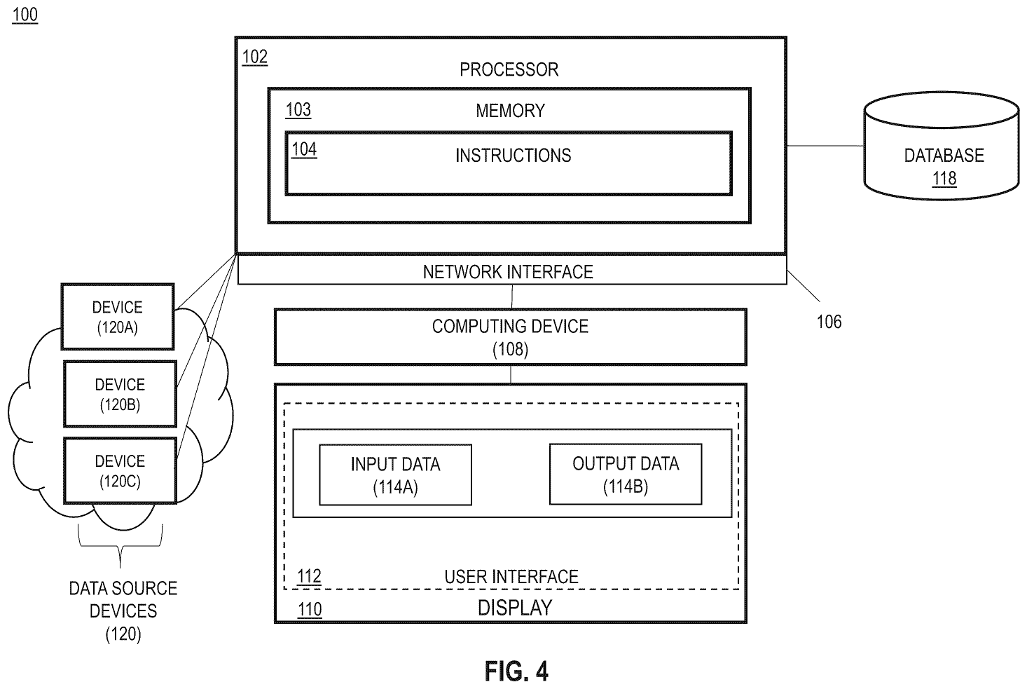

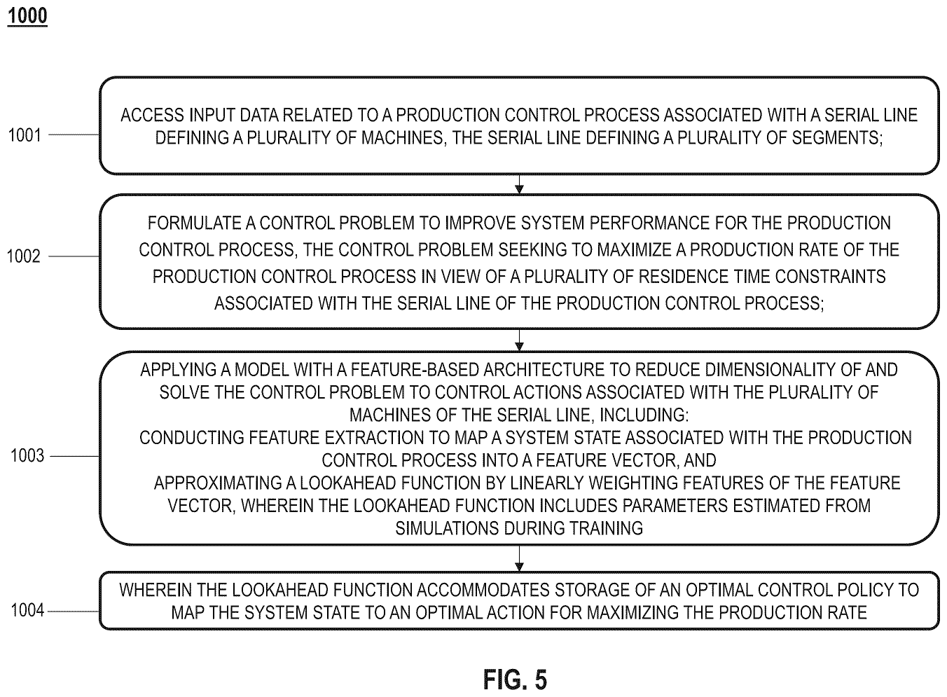

Referring to FIGS. 4-5, example implementations associated with the inventive concept herein are illustrated. FIG. 4 is a simplified block diagram of a system 100 configured to be AI driven for simulation-based real-time control to improve production control in face of various classes of residence time constraints

In general, the system 100 leverages artificial intelligence for simulation-based real-time control to improve production control in face of various classes of residence time constraints. While the present inventive concept is described primarily as an implementation of the system, it should be appreciated that the inventive concept may also take the form of tangible, non-transitory, computer-readable media having instructions encoded thereon and executable by a processor, and any number of methods related to examples of the system described herein.

In some examples, the system 100 includes at least one processor 102, and at least one of a memory 103 or storage device storing instructions 104 accessible by the processor 102 to perform various functions and operations described herein. The system 100 can further include a network interface 106 (or multiple network interfaces), and a bus (or wireless medium) for interconnecting the aforementioned components. The network interface 106 includes the mechanical, electrical, and signaling circuitry for communicating data over links (e.g., wires or wireless links) within a network (e.g., the Internet). The network interface 106 may be configured to transmit and/or receive data using a variety of different communication protocols, as will be understood by those skilled in the art.

In general, the processor 102 is configured (via the instructions 104) to execute any number of services, functions, or operations (e.g., blocks 1001-1004 of FIG. 5) via implementation of one or more models (e.g., AI models). AI models include, but are not limited to, machine learning models such as linear/logistic regression, decision trees, etc. AI models can include deep learning such as implementation of neural networks, large language models, generative AI, k-nearest neighbors, support vector machines, random forest, generative adversarial networks, and may include supervised models, unsupervised models, and/or combinations thereof.

In various examples, the processor 102 accesses input data 114A (which can include information about a serial production line) which may be provided by an external computing device 108 (e.g., by a user engaging a user interface 112 rendered along a display 110), and the processor 102 can return an output (e.g., a decision) in the form of output data 114B for access by the computing device 108. The output data 114B can define parameters or other information for optimal control of machines associated with the serial line.

In addition, the processor 102 can leverage datasets and other information to train, tune, and/or update one or more artificial intelligence models which can be leveraged to control production via recommended actions of the machines of the serial line in face of various classes of residence time constraints as described herein. For instance, the processor 102 can access data from one more data source devices 120 shown by example as device 120A, device 120B, and device 120C. Datasets and other information can be preprocessed and stored within a database 118 as shown.

The instructions 104 can be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

Referring to FIG. 5, a general example process 1000 associated with the AI-drive simulation-based real time control concepts is shown. Process includes various steps, operations, and/or functions, at least some of which can be encoded or programmed within instructions 104 and executable by the processor 102. In block 1001, the processor 102 access input data related to a production control process associated with a serial line defining a plurality of machines. The serial line can further define a plurality of segments as described herein.

In block 1002, the processor 102 is implemented to formulate a control problem to improve system performance for the production control process, the control problem seeking to maximize a production rate of the production control process in view of a plurality of residence time constraints associated with the serial line of the production control process.

In block 1003, the processor 102 applies a model with a feature-based architecture to reduce dimensionality of and solve the control problem to control actions associated with the plurality of machines of the serial line, including: conducting feature extraction to map a system state associated with the production control process into a feature vector, and approximating a lookahead function by linearly weighting features of the feature vector, wherein the lookahead function includes parameters estimated from simulations during training. As noted in block 1004, the lookahead function accommodates storage of an optimal control policy to map the system state to an optimal action for maximizing the production rate

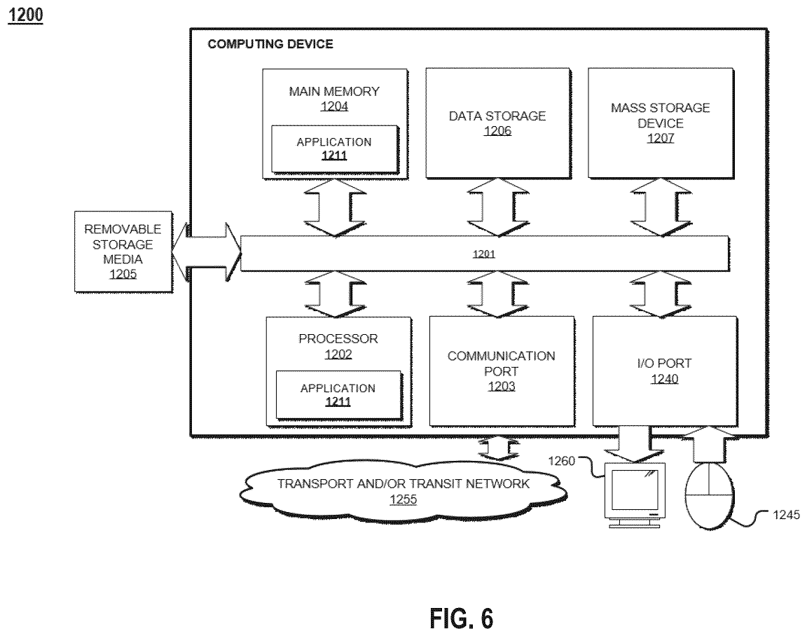

Referring to FIG. 6, a computing device 1200 is illustrated which may be configured, via the instructions 104 and/or other computer-executable instructions, to execute functionality described herein. More particularly, in some embodiments, aspects of the system and/or methods described herein may be translated to software or machine-level code, which may be installed to and/or executed by the computing device 1200 such that the computing device 1200 is configured to functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201 but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

Additional aspects of this disclosure are set out in the independent claims and preferred features are set out in the dependent claims. Features of one aspect may be applied to each aspect alone or in combination with other aspects. In addition, while certain operations in the claims are provided in a particular order, it is appreciated that such order is not required unless the context otherwise indicates.

What is claimed is:

1. A method for artificial intelligence (AI) driven simulation-based real-time control to improve production control in face of various classes of residence time constraints, comprising:
accessing input data related to a production control process associated with a serial line defining a plurality of machines, the serial line defining a plurality of segments; and
formulating a control problem to improve system performance for the production control process, the control problem seeking to maximize a production rate of the production control process in view of a plurality of residence time constraints associated with the serial line of the production control process;
applying a model with a feature-based architecture to reduce dimensionality of and solve the control problem to control actions associated with the plurality of machines of the serial line, including:
conducting feature extraction to map a system state associated with the production control process into a feature vector, and
approximating a lookahead function by linearly weighting features of the feature vector, wherein the lookahead function includes parameters estimated from simulations during training,
wherein the lookahead function accommodates storage of an optimal control policy to map the system state to an optimal action for maximizing the production rate.

2. The method of claim 1, wherein simulation is applied in the training to estimate parameters of the feature-based approximate architecture, so the lookahead function in the model can be approximately obtained.

3. The method of claim 1, wherein the plurality of residence time constraints includes are categorized into a plurality of classes, the plurality of classes constraints between adjacent processes of the production control process.

4. The method of claim 1, wherein the production control process is a semiconductor line and the segments relate to aspects of semiconductor manufacturing.

5. The method of claim 1, wherein the model is a Markov Decision Process (MDP), and a feature extraction method and a feature based approximate architecture reduce state space of the model.

6. A non-transitory medium having instructions encoded thereon, the instructions executable by a processor, to:
access input data related to a production control process associated with a serial line defining a plurality of machines, the serial line defining a plurality of segments; and
formulate a control problem to improve system performance for the production control process, the control problem seeking to maximize a production rate of the production control process in view of a plurality of residence time constraints associated with the serial line of the production control process; and
apply a model with a feature-based architecture to reduce dimensionality of and solve the control problem to control actions associated with the plurality of machines of the serial line.

7. A system for production control with different classes of residence time constraints, comprising:
a processor; and
a memory in operable communication with the processor, the memory storing instructions executable by the processor such that the processor is configured to:
access input data associated with a serial line defining a plurality of machines; and
apply the input data associated with the serial line to a model configured for simulation-based real-time production control for the serial line related to residence time using a plurality of classes of residence time constraints, wherein the model is trained to output parameter settings defining system states to control the plurality of machines so as to increase production rate and reduce scrape rate.

8. The system of claim 7, wherein the model is trained by simulating random different states of the plurality of machines according to different possible control policies.

9. The system of claim 7, wherein the model leverages a Markov decision process and feature-extraction method and feature-based approximation architecture to reduce state space of the model.

10. The system of claim 7, wherein simulation is employed in training the model to estimate parameters of feature-based approximate architecture to obtain a lookahead function of the Markov decision process.
